(19) United States
(12) Patent Application Publication
(10) Pub. No.: US 2004/0147351 A1
(43) Pub. Date: Jul. 29, 2004

(54) Toothed transmission belt provided with a metal core, transmission device comprising this belt and method for manufacture of the belt

(75) Inventor: Mauro Zona, Torino (IT)

Correspondence Address: SUGHRUE MION, PLLC, 2100 PENNSYLVANIA AVENUE, N.W., SUITE 800, WASHINGTON, DC, 20037, US

(73) Assignee: Pedri ROBERTA

(21) Appl. No.: 10/753,392

(22) Filed: Jan. 9, 2004

(30) Foreign Application Priority Data
Jan. 14, 2003 (IT) TO2003A000010

(51) Int. Cl. F16G 1/28; F16G 1/12

(52) U.S. Cl. 474/205; 474/250; 474/270

(57) ABSTRACT

A toothed transmission belt comprises a metal core including two mutually parallel and spaced apart metal strips, substantially coplanar to each other, and a plurality of metal cross-members, distributed according to a constant pitch in the longitudinal direction of the belt, which connect the two metal strips to each other.

### BACKGROUND OF THE INVENTION

The present invention relates to the field of toothed transmission belts, of the type comprising a metal core coated with elastomer material.

The object of the invention is to provide a toothed transmission belt of the type indicated above which has a precise and reliable operation while being at the same time simple and relatively inexpensive to manufacture.

### SUMMARY OF THE INVENTION

In view of achieving this and other objects, the invention provides a toothed transmission belt, comprising a metal core coated with elastomer material, characterised in that said metal core comprises at least two mutually parallel and spaced apart metal strips, substantially coplanar with each other, positioned in the longitudinal direction of the belt and a plurality of metal cross-members distributed according to a constant pitch in the longitudinal direction of the belt, which rigidly connect the two metal strips to each other and each whereof constitutes the core of a respective tooth of the toothed belt.

Thanks to the arrangement of the metal core described above, the transmission belt according to the invention is characterised by high dimensional stability and consequent precision of operation over time. Moreover, the structure is such as to allow its fabrication with extremely simple operations and at a relatively low cost.

According to an additional preferred characteristic, the cross members of the metal core of the transmission belt, and consequently also the teeth of the transmission belt, have a trapeze-shaped cross section.

In an embodiment, the cross-members of the metal core, and consequently also the teeth of the toothed belt, have a trapeze shaped section also in a plane that is orthogonal to the longitudinal direction of the belt, with the ends of each cross member and of each tooth defining mutually converging inclined planes. In the case of this embodiment, therefore, each tooth assumes a pyramidal shape with its base elongated in the transverse direction relative to the longitudinal direction of the belt. Naturally, if the toothed belt is provided with teeth of this kind, it will be destined to co-operate with gear wheels having seats for the engagement of the teeth of the belt in the form of cavities having a shape complementary to the shape of each tooth of the belt. A precise engagement will thus be achieved not only with reference to the position of the belt relative to the gear wheel in the tangential direction of the wheel, but also relative to a direction transverse to the longitudinal direction of the belt.

In a first embodiment, the cross members of the metal core are constituted by metal bars with solid or hollow cross-section, welded to the two longitudinal metal strips of the core. In a second embodiment, each cross-member is constituted by a hollow section bar obtained by a bending operation starting from a metal metal sheet. In this solution, the metal sheet of each cross member has a pair of slots traversed respectively by the two longitudinal strips of the metal core.

### BRIEF DESCRIPTION OF THE DRAWINGS

Further features and advantages shall become more readily apparent from the description that follows with reference to the accompanying drawings, provided purely by way of non limiting example, in which:

FIG. 1 is a partially sectioned perspective view of a first embodiment of a toothed transmission belt according to the invention,

FIG. 2 is a lateral view of the belt of FIG. 1,

FIG. 3 is an enlarged scale, sectioned view of the detail indicated by the arrow III in FIG. 2,

FIG. 4 is a partial perspective view of a gear wheel meshing with the transmission belt of the invention, and

FIG. 5 is a partial, sectioned perspective view of a second embodiment of the transmission belt according to the invention.

### DETAILED DESCRIPTION OF THE INVENTION

In the drawings, the reference number 1 generally designates a toothed transmission belt comprising a metal core 2 coated with a layer of rubber 3.

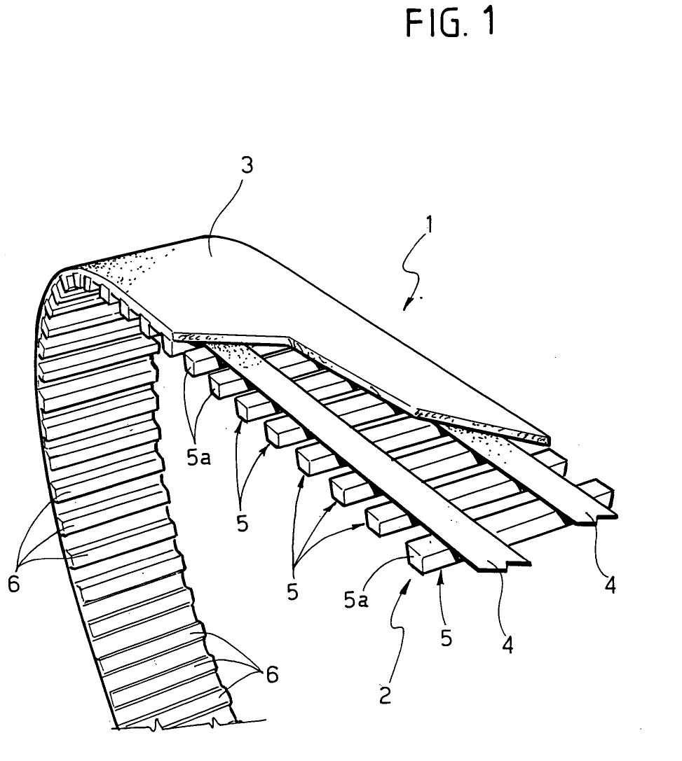

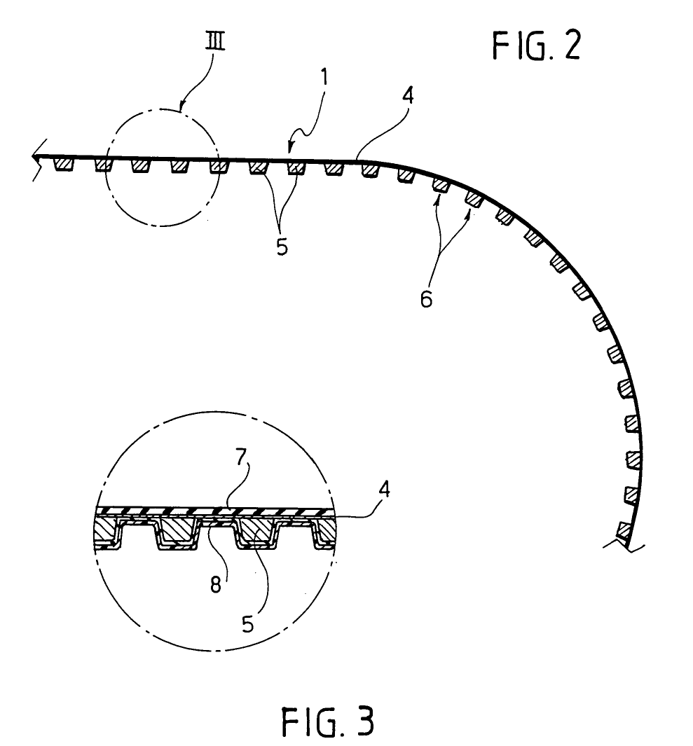

In the case of the first embodiment of the invention shown in FIGS. 1-4, the metal core comprises two mutually parallel and spaced apart metal strips, substantially coplanar to each other and extending in the longitudinal direction of the belt. The two metal strips 4 are mutually connected by a plurality of metal cross members 5 which extend transversely relative to the longitudinal direction of the belt and which are connected by any connecting means (in the illustrated example, by means of welding) to the two metal strips 4. The metal cross members 5 are distributed according to a constant pitch in the longitudinal direction of the belt and each of them constitutes the core of a respective tooth 6 of the toothed transmission belt.

The cross members 5 therefore constitute the resistant metal structure which assures the adequate characteristics of strength of the teeth of the belt, with high dimensional stability over time, which makes the operation of the transmission belt according to the invention extremely reliable.

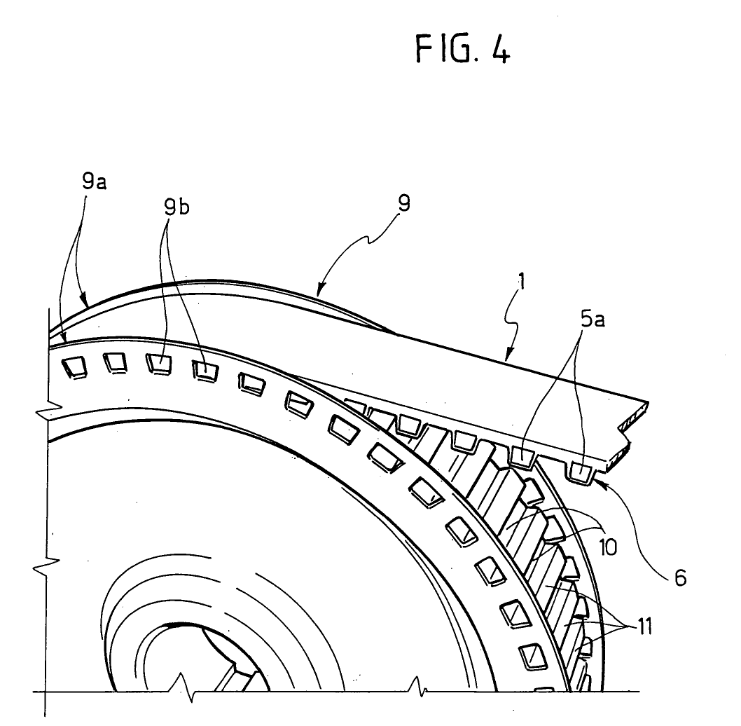

The two metal strips 4 serve the sole function of connecting the metal cross members 5 to each other and are sufficiently flexible to allow the correct operation of the belt in the areas where it has to assume a curvature to be engaged over a respective gear wheel (see FIG. 4). As indicated above, the core 2 is provided with a rubber coating that covers all metal surfaces, with the exception of the end surfaces 5a (see FIG. 1) of the metal cross-members 5. Moreover, in correspondence with the face of the transmission belt bearing the teeth 6, over the rubber coating is applied an additional coating of adhesion-proof plastic material (for example, nylon) 8 (FIG. 3).

FIG. 4 shows a gear wheel 9 engaged with the transmission belt 1 according to the invention. In the illustrated example, each tooth 6 has a trapeze shaped cross-section, whereto corresponds a complementarily shaped cavity 10 constituted by a recess between two adjacent teeth 11. The wheel 9 also has two end flanges 9a which laterally guide the transmission belt 1. If desired, each tooth 6 can also have a trapeze shaped section in a plane that is perpendicular to the longitudinal direction of the belt. In this case, the two end surfaces 5a of each metal cross-member are inclined and converging planar surfaces, in such a way that the entire shape of each tooth is a pyramidal shape, elongated in the transverse direction of the belt. In this case, the flanges 9a can also be arranged with a corresponding inclination so that they diverge from each other in a radial direction outwardly. Additionally, or alternatively to the aforesaid arrangement, the flanges 8a can be provided with a circumferential series of windows 9b in correspondence with the recesses 10 between the adjacent teeth 11 of the wheel. Said windows come to be in correspondence with the end surfaces 5a of the metal cross-members and avoid any contact or rubbing with said surfaces. If the windows 9b are provided, the end surfaces 5a of the cross members or the metal core need not be coated with rubber, as done in the case of the embodiment shown in FIG. 4.

In the fabrication of the transmission belt shown in FIGS. 1-4, the metal core 2 is initially arranged. This can be accomplished by means of a continuous process, in an extremely efficient and rapid manner. The connection between cross-members 5 and metal strips 4 can be obtained for example by means of welding, making the two metal strips 4 advance continuously starting from feeding reels and welding over them in succession the cross members 5 coming from a supplier device, whereupon the subsequent rubber coating can also be obtained continuously, during the longitudinal advance of the metal core thus obtained. The same also holds true for the adhesion-proof coating on the toothed surface of the belt. Any desire length of belt can then be obtained by cutting the continuous belt thus produced and joining the ends of the cut belt portion by any known technique.

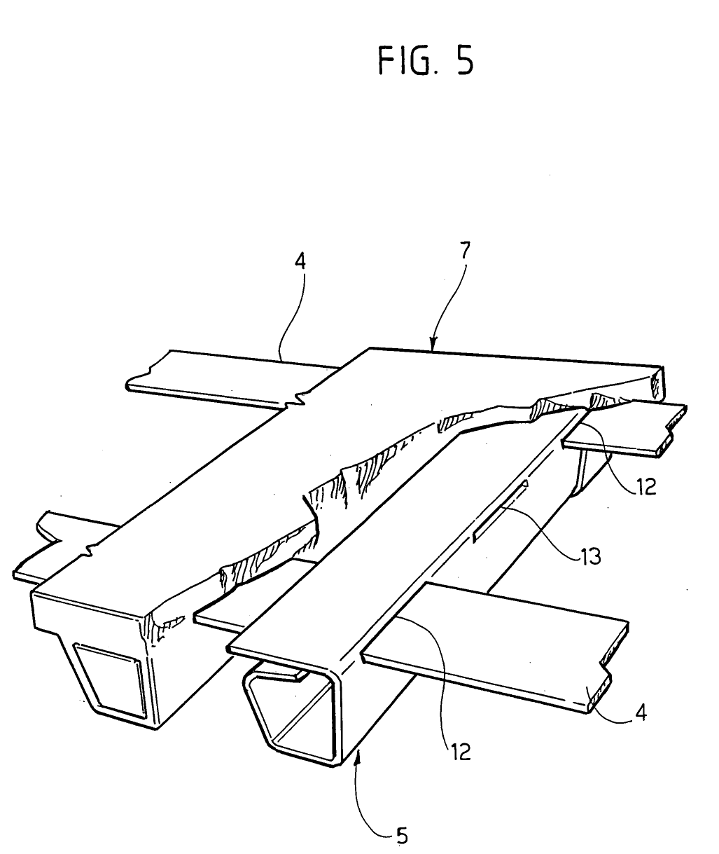

FIG. 5 shows an alternative embodiment, in which the cross-members 5, instead of being constituted by solid metal bars, are obtained by a bending operation starting from a metal sheet, to assume the shape of hollow section bars. The starting metal sheet is bent four times, in correspondence with the four corners of the cross-member 5, with the two end edges of the bent metal sheet superposed on each other, as illustrated in FIG. 5. The metal sheet also has two slots 12, and if desired also a third central slot 13, which are respectively traversed by the two metal strips 4 and possibly by an additional central metal strip (not shown herein). Once said metal core is arranged, the rubber coating 7 is applied as usual.

In operation, the transmission belt according to either the first embodiment of the invention described above or the embodiment shown in FIG. 5, or any further embodiment implementing the basic concepts of the invention, is reliable and precise in operation and it is also able to be applied to transmissions that imply the transfer of high transmission power, assuring the necessary characteristics of strength and a high dimensional stability and a prolonged duration.

Naturally, without altering the principle of the invention, the construction details and the embodiments may be varied widely from what is described and illustrated herein purely by way of example, without thereby departing from the scope of the present invention.

What is claimed is:

1. A toothed transmission belt, comprising a metal core coated with elastomer material, wherein said metal core comprises at least two mutually parallel and spaced apart metal strips, substantially coplanar to each other, arranged in the longitudinal direction of the belt, and a plurality of metal cross-members, distributed according to a constant pitch in the longitudinal direction of the belt, which rigidly connect the two metal strips to each other and each whereof constitutes the core of a respective tooth of the toothed belt.

2. A toothed transmission belt as claimed in claim 1, wherein each cross-member of the aforesaid metal core, and consequently each tooth of the toothed transmission belt has a trapeze-shaped cross section.

3. A toothed transmission belt as claimed in claim 2, wherein each cross member of the metal core is constituted by a solid section metal bar.

4. A toothed transmission belt as claimed in claim 1, wherein each cross member is constituted by a hollow section bar obtained by a bending operation, starting from a metal sheet.

5. A toothed transmission belt as claimed in claim 3, wherein the metal sheet constituting each cross member has slots traversed by the aforesaid metal strips.

6. A toothed transmission belt as claimed in claim 1, wherein the cross members are welded to the two metal strips.

7. A toothed transmission belt as claimed in claim 2, wherein each cross member of the metal core and consequently each tooth of the toothed transmission belt has a trapeze-shaped cross-section also in a plane that is orthogonal to the longitudinal direction of the belt, with the end surface of each tooth positioned in mutually converging inclined planes.

8. A toothed transmission belt as claimed in claim 1, wherein the toothed surface of the belt has a layer of adhesion-proof coating over the rubber coating.

9. Belt transmission device comprising a toothed transmission belt as claimed in any of the previous claims and a gear wheel meshing with said toothed belt, wherein said wheel has a plurality of peripheral teeth alternating with cavities and two end flanges which constitute the ends of the cavities.

10. A belt transmission device as claimed in claim 9, wherein said end flanges of the gear wheel have a circumferential distribution of windows corresponding to the ends of the cavities between the teeth of the gear wheel, to prevent a contact between the inner surfaces of said flanges and the end surfaces of the teeth of the toothed transmission belt.

11. A method for manufacturing a toothed belt according to claim 1, wherein the two parallel and spaced apart metal strips are caused to advance continuously by unrolling them from two feeding reels, said metal cross-members are connected in sequence to the metal strips while the strips are proceeding forward, by feeding the cross-members from a cross-member supplier, and the metal core obtained thereby is coated with a layer of elastomer material while said core is advancing.
